(19) United States
(12) Patent Application Publication
(10) Pub. No.: US 2010/0037850 A1
(43) Pub. Date: Feb. 18, 2010

(54) OIL PAN FOR AN INTERNAL COMBUSTION ENGINE

(75) Inventor: Thomas Jessberger, Asperg (DE)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/539,048

(22) Filed: Aug. 11, 2009

(30) Foreign Application Priority Data
Aug. 14, 2008 (DE) 20 2008 010 865.9

(51) Int. Cl. F02M 35/02; F16K 31/02

(52) U.S. Cl. 123/198 E; 251/129.01

(57) ABSTRACT

An oil pan for an internal combustion engine has a casing having a first oil chamber and a second oil chamber that are separated from one another. A valve connects the first and second chambers with one another in an open position of the valve. The valve is switched temperature dependent, wherein the valve is closed at a temperature below a switching temperature. An outlet opening communicates with the first oil chamber. The first oil chamber has a first oil volume and the second oil chamber has a second oil volume, wherein the first oil volume is smaller than the second oil volume. The outlet opening is positioned in an exterior wall of the first oil chamber and provides a connecting opening for connecting an oil cooler to be connected to an exterior wall of the casing.

### CROSS REFERENCE TO RELATED APPLICATIONS

Priority is claimed based on Federal Republic of Germany patent application no. DE 20 2008 010 865.9 filed Aug. 14, 2008.

### TECHNICAL FIELD

This disclosure relates to an oil pan for an internal combustion engine and, more particularly, to an oil pan having two oil chambers that are connected to one another by a valve that is switched as a function of temperature.

### BACKGROUND OF THE INVENTION

JP 2003278519 A discloses an oil pan for an internal combustion engine whose interior is separated by a partition into two separate chambers approximately of the same size and each filled with oil. One of the two chambers is connected to an outlet passage through which the oil can be discharged from this chamber. The separation into two chambers has the advantage of reduced oil volume for each chamber so that in operation at low temperatures the oil can be heated in a shorter period of time to operating temperature. Several connecting openings are provided in the partition between the oil chambers and are to be opened and closed by a switching valve acting temperature dependent, respectively. At higher temperatures, the switching valves are opened in order to generate a flow connection between the two oil chambers so that the oil volume of both oil chambers can be supplied to the oil circulation. As a whole, in this way the oil volume in the oil pan is brought within a shorter period of time to operating temperature; this is beneficial with regard to CO2 emissions.

There remains a need in the art for an oil pan configured to bring the oil temperature in an internal combustion engine within a short period of time to operating temperature which is also provides a more compact configuration of the components of the oil circuit.

### SUMMARY OF THE INVENTION

It is an object of the present invention to bring the oil temperature in an internal combustion engine within a short period of time to operating temperature wherein a compact configuration of the components of the oil circuit is desirable. In accordance with the present invention, this is achieved in that the first oil chamber that communicates with the outlet opening has a smaller volume than the second oil chamber in the oil pan and in that the outlet opening is provided in the exterior wall of the smaller oil chamber and provides a connecting opening for connecting to an oil cooler that is connectable to the exterior wall of the oil pan.

The oil pan according to the invention for an internal combustion engine is provided with two separate oil chambers that are each provided for receiving an oil volume wherein the two oil chambers are connected to one another by a valve that is to be switched depending on temperature. The two oil chambers have differently sized volumes wherein the smaller oil chamber is in communication with an outlet opening for discharging the oil and wherein the exterior wall of the smaller oil chamber is provided with a connecting opening by means of which a connection to an oil cooler connectable to the exterior wall of the oil pan is realizable.

By means of the differently sized oil volumes of the two oil chambers depending on the outer temperature and the oil temperature a two-stage heating phase can be realized. At low temperatures below the switching temperature the valve remains closed so that the two oil chambers are separated from one another and oil exchange between the chambers is prevented. During this phase, oil is exclusively supplied from the smaller oil chamber through the outlet opening into the oil circulation. Advantageously, the smaller oil volume of this chamber enables a fast heating up of the oil to the point of reaching the switching temperature of the valve.

Upon the oil volume of the smaller oil chamber reaching the switching temperature, the second phase begins in which the valve between the two chambers is opened so that a flow connection between the oil volumes in both chambers is realized. By conveying the oil from the first smaller chamber into the oil circulation, the oil pressure in the first chamber is reduced which effects a transfer flow of oil from the second larger oil chamber through the open valve into the first oil chamber. In this way it is ensured that after reaching the switching temperature the entire oil volume comprised of the individual volumes of the two oil chambers is supplied to the oil circulation.

The switching temperature of the valve expediently coincides with the normal operating temperature. Basically, a deviation of the switching temperature from the operating temperature is possible, for example, in such a way that the switching temperature is lower than the operating temperature in order to open the valve already before reaching the operating temperature and to provide a flow connection between the oil chambers.

The present invention is distinguished moreover by a compact configuration because only a single outlet opening is required in the oil pan in order to dispense the oil below the switching temperature exclusively from the smaller oil chamber or above the switching temperature from both oil chambers. The outlet opening represents at the same time also a connecting opening by means of which the smaller oil chamber is connected to the oil cooler that is connectable to the exterior wall of the oil pan. The outlet or connecting opening is provided in the exterior wall of the oil pan in the area of the smaller oil chamber. In this way, a device is realized comprising an oil pan and an oil cooler that is flanged to the exterior wall of the oil pan and is downstream of the smaller oil chamber of the oil pan and through which the oil discharged from the smaller oil chamber is passed. By means of flanging the oil cooler to the exterior wall of the oil pan a small-size configuration is achieved that, at the same time, has the advantage of reduced pressure losses as a result of the short flow paths.

This embodiment is expediently combined with an arrangement of an oil pump in the oil pan which oil pump is preferably located in the smaller oil chamber. In this way, short connections are achieved between the oil pump in the smaller oil chamber that conveys the oil from the bottom of the smaller oil chamber and the oil cooler that is flanged to the exterior wall of the oil pan and delimits the smaller oil chamber.

According to a further expedient embodiment it is provided that the smaller oil chamber in the oil pan is closed off by a lid. The lid reduces a cooling effect resulting in particular by head wind and enables in this way at low ambient temperatures a faster heating of the oil volume in the smaller oil chamber. Closing the smaller oil chamber by means of the lid has also the additional advantage that when maneuvering curves, when braking or driving across uneven road surfaces no oil will spill over from one to the other of the two oil chambers so that the two oil volumes remain separated.

Moreover, according to a further advantageous embodiment it is provided that the smaller oil chamber is of an L-shape and extends across a corner of the oil pan.

According to a further advantageous embodiment, the smaller oil chamber has an oil return passage that together with the outlet opening closes the oil circulation. Expediently, exclusively the smaller oil chamber is provided with an oil return passage, but not the larger oil chamber, so that in particular in the first phase in which the temperature is below the switching temperature and the valve between the oil chambers is closed, oil is returned exclusively into the smaller oil chamber and oil of the smaller oil chamber is dispensed into the oil circulation but no oil from the larger oil chamber. The larger oil chamber is connected only once the switching temperature has been reached and the valve between the two oil chambers is thus opened.

In order to realize an overflow, it can be expedient to provide the upper area of the wall (partition) between the two oil chambers or in the lid of the smaller oil chamber an overflow opening through which the oil at a correspondingly high oil level in the smaller oil chamber can flow into the larger oil chamber. For example, the opening is realized by a gap between the oil return passage and the lid or a sidewall of the smaller oil chamber.

In case of an open embodiment of the smaller oil chamber where no closure lid is provided it is expedient to provide the partition between the two oil chambers with a maximum height that is lower than the exterior wall of the oil pan so that an overflow across the edge of the partition between the oil chambers is enabled.

The valve that is switched temperature dependent can be embodied as a passive actuator that upon reaching the switching temperature switches automatically but also as an active actuator that is switched between its closed and its open position by means of control signals and by means of energy supply. The passive actuator which requires no control by means of control signals and also no energy-consuming actuating member is, for example, embodied as a bimetallic spring or as a wax expansion element that comprises a wax-filled capsule and generates upon temperature increase an adjusting travel that serves for opening a valve member. In case of an active actuator a temperature sensor is required in order to determine the actual oil temperature or another temperature that is important for opening the valve and to generate by means of a control device control signals for opening and closing the active actuator. This embodiment has the advantage that various switching points can be predetermined at which the valve member is actuated into the open position or closed position. It is possible, for example, to determine a switching temperature below the operating temperature wherein the temperature differential between the switching temperature and the operating temperature may be dependent on various state parameters and ambient parameters, for example, the ambient temperature.

For a fast heating of the oil it can be expedient to make the volume of the smaller oil chamber maximally half that of the volume of the larger oil chamber.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 is a perspective view of an oil pan with two oil chambers as well as an oil cooler that is to be flanged to the exterior wall of the oil pan and an oil pump that is to be integrated into the smaller oil chamber in the oil pan; and

FIG. 2 shows in an enlarged illustration a valve that opens and closes a flow opening in a partition between the two oil chambers.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to an oil pan for an internal combustion engine having multiple oil chambers interconnected by a temperature actuated valve as disclosed herein. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

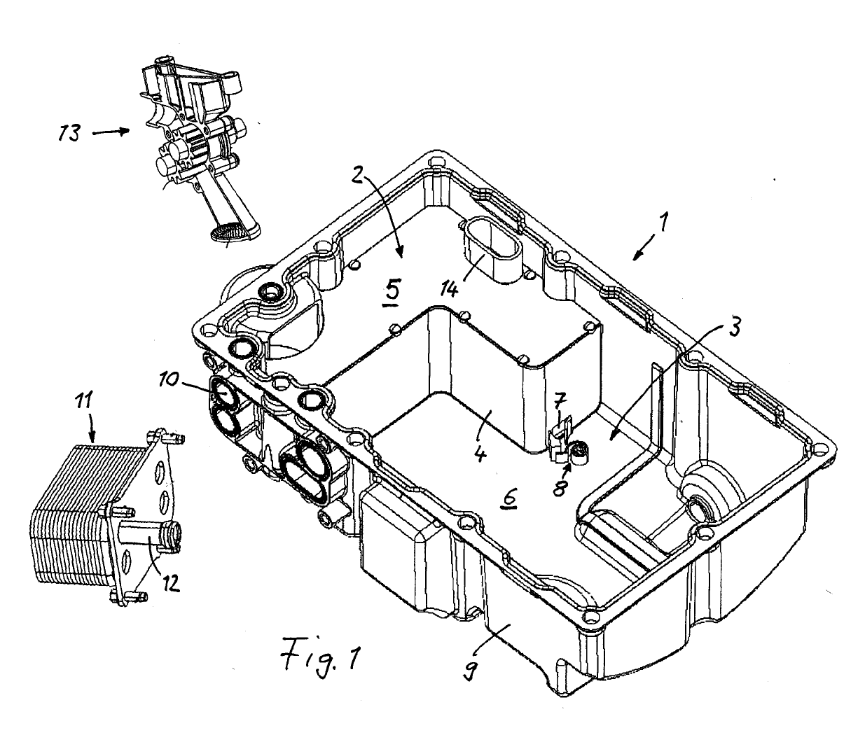

FIG. 1 shows that the oil pan 1 that is to be arranged at the bottom side of the crankcase of an internal combustion engine is provided in the interior of its casing with a small oil chamber 2 and a large oil chamber 3 that are separated from one another by a partition 4. The smaller oil chamber 2 has a lid 5 and is outwardly completely closed. The large oil chamber 3 on the other hand is open in the upward direction. The partition 4 has a smaller height than the outer wall 9 of the oil pan 1.

Adjacent to the bottom 6 a flow opening 7 is provided in the partition 4 and enables a flow connection between the oil chambers 2 and 3. The flow opening 7 is closed by a valve 8 that switches temperature dependent and that is in a closed position below a specific switching temperature and, above the switching temperature, is actuated to the open position in which the flow opening 7 is open and the oil volumes in the two chambers 2 and 3 communicate with one another.

The smaller oil chamber 2 has an L-shaped cross-section and extends in the oil pan 1 across a corner of the casing as shown in FIG. 1 so that two adjoining exterior sides of the oil pan delimit the small oil chamber 2 in the outward direction. The small oil chamber 2 encloses a volume that is significantly smaller than the volume of the large oil chamber 3. For example, the volume of the small oil chamber 2 is maximally 50% of the volume of the large oil chamber 3.

An oil cooler 11 is arranged at the exterior wall of the oil pan 1 in the area of the small oil chamber 2 and comprises a connecting pipe 12 through which the supply of oil from the oil pan 1 is realized. The oil pan 1 is provided at the exterior wall of the small oil chamber 2 with a connecting opening 10 which serves for receiving the connecting pipe 12 of the oil cooler 11.

An oil pump 13 is integrated into the small oil chamber 2 and draws in oil from the bottom-near area of the small oil chamber 2 and conveys it by means of the connecting opening 10 and the connecting pipe 12 to the oil cooler 11.

An oil return passage 14 opens into the small oil chamber 2 by means of which the oil is introduced into the small oil chamber 2 in the oil pan 1. Optionally, in the area of the lid 5 of the small oil chamber 2 an overflow opening is provided that has the function of an overflow.

In operation of the internal combustion engine the valve 8 is closed as long as the operating temperature of the oil is below the switching temperature of the valve. When the valve 8 is closed only the oil volume in the small oil chamber 2 participates in the oil circulation. The oil that is supplied through the oil return passage 14 is conveyed by means of the oil pump 13 in the interior of the small oil chamber 2 through the connecting opening 10 to the oil cooler 11 and from there through an oil filter to the internal combustion engine. The oil volume that is contained in the large oil chamber 3 does not participate in the oil circulation when the valve 8 is closed.

Only once the switching temperature is reached the valve 8 opens so that the flow opening 7 is released and a flow connection between the oil volumes in the small oil chamber 2 and the large oil chamber 3 is realized. Since oil from the small oil chamber 2 is conveyed (pumped) to the exterior, the small oil chamber 2 is at a lower pressure than the large oil chamber 3, this lower pressure is operable to draw oil from the large oil chamber 3 through the flow opening 7 in the partition 4 into the smaller small oil chamber 2.

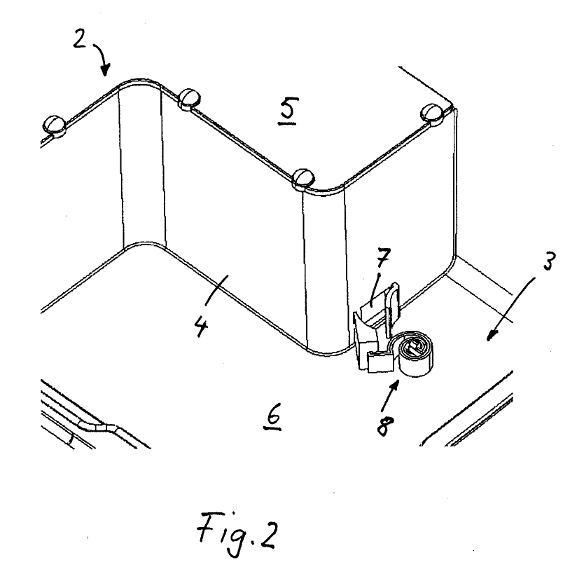

As shown in the enlarged illustration according to FIG. 2, the valve 8 is embodied as a bimetallic spring and thus forms a passive actuator that simply by means of the temperature of the oil can switch between open position and closed position. In this connection, expediently the oil in the small oil chamber 2 is the medium that loads the valve 8 so that the temperature of the oil in the small oil chamber 2 determines the switching action.

In place of a passive actuator as a valve, it is also possible to have active actuators, for example, solenoid actuators that are switched by means of electrical control signals as a function of the measured temperature.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. An oil pan for an internal combustion engine, comprising:
a casing having a first oil chamber and a second oil chamber that are separated from one another;
a valve connecting said first and second chambers with one another in an open position of said valve, wherein said valve is switched temperature dependent, wherein said valve is closed at a temperature below a switching temperature; and
an outlet opening communicating with said first oil chamber;
wherein said first oil chamber has a first oil volume and said second oil chamber has a second oil volume, wherein said first oil volume is smaller than said second oil volume; and
wherein said outlet opening is positioned in an exterior wall of said first oil chamber and provides a connecting opening for connecting an oil cooler that is adapted to be connected to an exterior wall of said casing.

2. The oil pan according to claim 1, wherein said first oil chamber has a lid closing off said first oil chamber.

3. The oil pan according to claim 1, wherein said first oil chamber is L-shaped and is positioned across a corner of said casing.

4. The oil pan according to claim 1, comprising an oil return passage that opens into said first oil chamber.

5. The oil pan according to claim 1, comprising a partition that separates said first and second oil chambers from one another, wherein said valve is disposed adjacent to a bottom of said oil pan in said partition.

6. The oil pan according to claim 1, wherein said valve is a passive actuator that switches automatically upon reaching said switching temperature.

7. The oil pan according to claim 6, wherein said passive actuator is a bimetallic spring.

8. The oil pan according to claim 6, wherein said passive actuator is a wax expansion element.

9. The oil pan according to claim 1, wherein said valve is an active actuator that upon reaching said switching temperature is switched by electric control signals.

10. The oil pan according to claim 1, comprising an oil pump integrated into said casing.

11. The oil pan according to claim 10, wherein said oil pump is arranged in said first oil chamber.

12. The oil pan according to claim 1, wherein said first oil volume of said first oil chamber is maximally half of said second oil volume of said second oil chamber.
